(19) United States
(12) Patent Application Publication
(10) Pub. No.: US 2011/0131040 A1
(43) Pub. Date: Jun. 2, 2011

(54) MULTI-MODE SPEECH RECOGNITION

(75) Inventors: Ritchie Huang, Torrance, CA (US); Stuart M. Yamamoto, Hacienda Heights, CA (US); David M. Kirsch, Torrance, CA (US)

(73) Assignee: HONDA MOTOR CO., LTD, Tokyo (JP)

(21) Appl. No.: 12/628,476

(22) Filed: Dec. 1, 2009

(51) Int. Cl. G10L 15/00; G10L 21/00

(52) U.S. Cl. 704/231; 704/275; 704/E15.001; 704/E21.001

(57) ABSTRACT

A method and an in-vehicle system having a speech recognition component are provided for improving speech recognition performance. The speech recognition component may have multiple vocabulary dictionaries, each of which may include phonetics associated with commands. When the in-vehicle system receives speech input, the speech recognition component may determine whether the received speech input includes a speech access command. If the received speech input is determined to include a speech access command, then a dictionary changing component may transition a currently-used dictionary of the speech recognition component to a vocabulary dictionary associated with the determined speech access command. Otherwise, the dictionary changing component may transition the currently-used dictionary to a first vocabulary dictionary. A command included in the received speech input may then be recognized by the speech recognition component using the transitioned currently-used dictionary.

### BACKGROUND

1. Field of the Invention

The present teachings relate to methods and speech recognition systems for utilizing a plurality of vocabulary dictionary databases. In particular, the present teachings relate to selection of one of the plurality of vocabulary dictionary databases for use by a speech recognition system.

2. Discussion of Related Art

A speech recognition system uses one or more vocabulary dictionary databases in order to phonetically match an utterance of a user. Speech recognition control in existing speech recognition systems is limited by a size of a vocabulary dictionary database and a type of available commands. Typically, as a size of a vocabulary dictionary database increases, recognition accuracy of a speech recognition system decreases. This is especially true when a music song title is included in a speech command due to a level of variability of music song titles, which may sound similar to existing speech commands of a speech recognition system.

Some existing speech recognition systems utilize multiple vocabulary dictionary databases to improve recognition accuracy. In one existing speech recognition system, the system uses a hierarchical structure of multiple dictionaries classified by at least one narrowing-down condition. For example, the one existing speech recognition system proceeds through a number of sequential speech-recognition input steps by subcategories, recognizing appropriate queuing words from different dictionaries utilized in response to speech input prompts.

In another existing speech recognition system, a number of speech recognition engines may be operated in parallel with each of the speech recognition engines using a different recognition model and a different dictionary database. The choice of which of the speech recognition engines to use can be predetermined or dynamically selected based on a context of user input. The recognition models may be hierarchically arranged to simplify selection of a suitable model.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

A method and an in-vehicle system having a speech recognition component are provided for improving speech recognition accuracy. In one embodiment, a speech recognition component may have two vocabulary dictionaries. Each of the two vocabulary dictionaries may include phonetics associated with a respective type of command. When speech input is received by the in-vehicle system, a determination may be made regarding whether the received speech input includes a speech access command. When the speech access command is determined to be included in the received speech input, a dictionary changing component of the in-vehicle system may cause a transition of a currently-used dictionary of the speech recognition component to a second one of the two vocabulary dictionaries. When the speech access command is not determined to be included in the received speech input, the dictionary changing component may transition the currently-used dictionary to a first one of the two vocabulary dictionaries. The speech recognition component of the in-vehicle system may recognize a command included in the received speech input by using the currently-used dictionary.

In another embodiment, a speech recognition component of an in-vehicle system may include two or more vocabulary dictionaries. Each of the two or more vocabulary dictionaries may be associated with a respective application and/or a mode of operation. When speech input is received, the speech recognition component may determine whether one of a number of speech access commands is included in the received speech input. When one of the number of speech access commands is determined to be included in the received speech input while the in-vehicle system is in any one of a number of modes of operation, then a dictionary changing component of the in-vehicle system may transition a currently-used dictionary of the speech recognition component to a vocabulary dictionary, of the two or more vocabulary dictionaries, associated with the determined one of the number of speech access commands. A command included in the received speech input may then be recognized by the speech recognition component using the currently-used dictionary.

In some embodiments, some of a number of vocabulary dictionaries may have specific algorithms associated therewith for supplementing, enhancing, or improving speech recognition performance when the speech recognition component uses a vocabulary dictionary, associated with a specific algorithm, to recognize speech input.

### BRIEF DESCRIPTION OF THE DRAWINGS

In order to describe the manner in which the above-recited and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates an exemplary in-vehicle system implemented by a computing device.

FIG. 2 illustrates a flowchart of an exemplary process which may be implemented by an in-vehicle system having a speech recognition component with two vocabulary dictionaries.

FIG. 3 shows an exemplary overlay screen, which, when displayed on a display device of an in-vehicle system, confirms transition of a currently-used dictionary used by a speech recognition component of the in-vehicle system.

FIG. 4 is a flowchart illustrating an exemplary process which may be implemented by an in-vehicle system having a speech recognition component with two or more vocabulary dictionaries.

### DETAILED DESCRIPTION

Overview

A method and an in-vehicle system having a speech recognition component are provided. The speech recognition component may have two vocabulary dictionary databases, each of which may be enabled for a particular mode or a particular application. For example, a first vocabulary dictionary database may have associated therewith a first set of speech commands, which may be used when the in-vehicle system is operating in a first mode, or executing a first application. A user may enable a transition to a second vocabulary dictionary database by providing, via speech input, an access command associated with a second vocabulary dictionary database. The second vocabulary dictionary database may have associated therewith a second set of speech commands, which may be used when the in-vehicle system is operating in a second mode, or when the in-vehicle system is executing a second application.

In another embodiment, the speech recognition component may have more than two vocabulary dictionary databases, each of which may be enabled for a particular mode of operation or a particular application. For example, a first vocabulary dictionary database may have associated therewith a first set of speech commands, which may be used when the in-vehicle system is operating in a first mode, or when the in-vehicle system is executing a first application. A second vocabulary dictionary database may have associated therewith a second set of speech commands, which may be used when the in-vehicle system is operating in a second mode, or when the in-vehicle system is executing a second application. A third vocabulary dictionary database may have associated therewith a third set of speech commands, which may be used when the in-vehicle system is operating in a third mode, or when the in vehicle system is executing a third application, etc. A user may enable a transition to any of the second through N^{th} vocabulary dictionary databases (assuming that the in-vehicle system has N vocabulary dictionary databases) by providing, via speech input, an access command associated with a desired one of the second through N^{th} vocabulary dictionary databases. The user may cause a transition to a desired one of the second through N^{th} vocabulary dictionary databases regardless of a mode in which the in-vehicle system is operating, or which application the in-vehicle system is currently executing, by providing, via speech input, an access command associated with the desired one of the second through N^{th} vocabulary dictionary databases. In some embodiments, when no access command is provided in a speech input, a first vocabulary dictionary database may be used by the speech recognition component to recognize the speech input.

Exemplary Devices

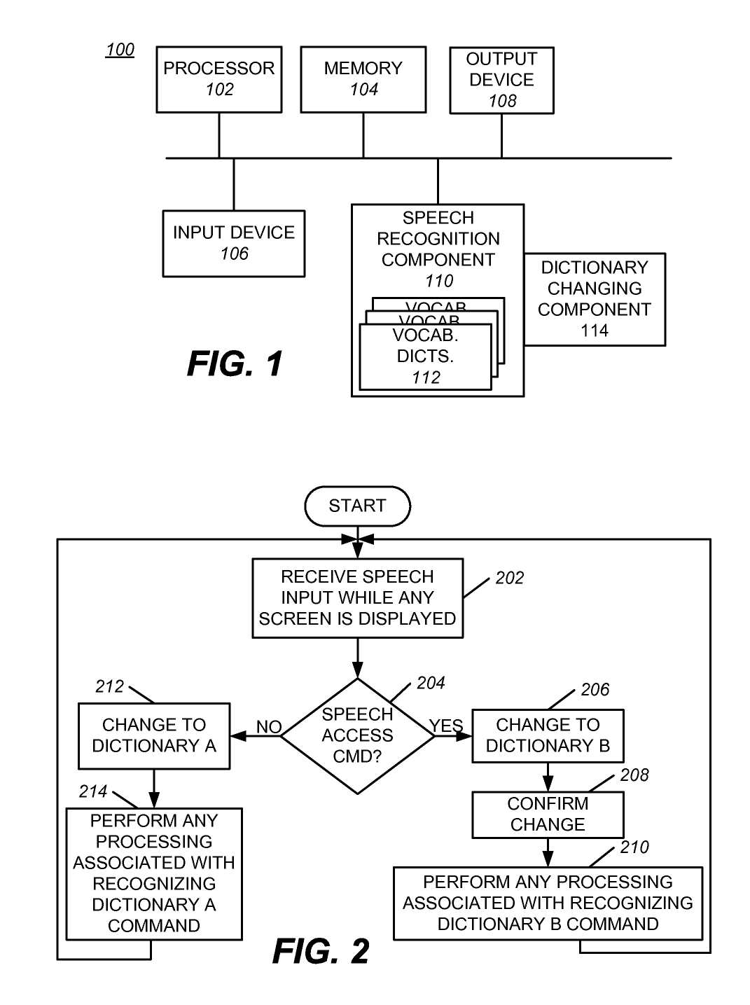

FIG. 1 is a functional block diagram of an exemplary embodiment of an in-vehicle system 100 implemented on a computing device. In-vehicle audio system 100 may include a processor 102, a memory 104, an input device 106, an output device 108, a speech recognition component 110, and a dictionary changing component 114.

Processor 102 may include one or more conventional processors that interpret and execute instructions stored in a tangible medium, such as memory 104, a media card, a flash RAM, or other tangible medium. Memory 104 may include random access memory (RAM) or another type of dynamic storage device, and read-only memory (ROM) or another type of static storage device, for storing information and instructions for execution by processor 102. RAM, or another type of dynamic storage device, may store instructions as well as temporary variables or other intermediate information used during execution of instructions by processor 102. ROM, or another type of static storage device, may store static information and instructions for processor 102.

Input device 106 may include a microphone, or other device, for speech input. Output device 108 may include one or more speakers, a headset, or other sound reproducing device for outputting sound, a display device for displaying output, and/or another type of output device.

Speech recognition component 110 may recognize speech input and may convert the recognized speech input to text. Speech recognition component 110 may include two or more vocabulary dictionary databases 112 (hereinafter, referred to as “vocabulary dictionaries”). Vocabulary dictionaries 112 may include phonetics corresponding to verbal commands. In some embodiments, one or more of vocabulary dictionaries 112 may include information referring to music, such as phonetics referring to, for example, music titles, names of albums, names of artists, genre, as well as other information. In some embodiments, speech recognition component 110 may include one or more software modules to be executed by processor 102.

Dictionary changing component 114 may be responsible for transitioning from one of vocabulary dictionaries 112 to another of vocabulary dictionaries 112. In some embodiments, dictionary changing component 114 may include one or more software modules, which, in some embodiments, may be included as part of speech recognition component 110. In other embodiments, dictionary changing component 114 may be separate from speech recognition component 110.

FIG. 2 is a flowchart illustrating exemplary processing in an embodiment having two vocabulary dictionaries. A first one of the vocabulary dictionaries may include phonetics corresponding to basic commands. In one embodiment, the basic commands may include commands related to one or more of climate control commands, audio system commands, and/or navigation commands, as well as other types of commands. A second one of the vocabulary dictionaries may include phonetics corresponding to one or more of music titles, names of albums, names of artists, and/or genre, as well as other information.

The process may begin with input device 106 of in-vehicle system 100 receiving speech input while in-vehicle system 100 is operating in any mode, or while any screen is displayed by a display device of in-vehicle system 100 (act 202). Speech recognition component 110 may then determine whether a speech access command is included in the received speech input (act 204). Speech access commands, in this embodiment, may include a specific word or a specific phrase, such as, for example, “play music title”, “play album title”, “list artist”, etc. For example, in one embodiment, a user may utter “play music title” indicating a desire for a vocabulary dictionary including music titles.

A received speech input may be of a form <speech access command indicating a desire for a second one of the vocabulary dictionaries> <command included in the second one of the vocabulary dictionaries>. Thus, in the above-mentioned embodiment, the user may utter “play music title Beethoven's Fifth Symphony”, where “play music title” is the speech access command indicating a desire for the second one of the vocabulary dictionaries, and “Beethoven's Fifth Symphony” is a music title which speech recognition component 110 may recognize using the second one of the vocabulary dictionaries.

If speech recognition component 110 determines that the received speech input includes a speech access command, then dictionary changing component 114 may transition a currently-used dictionary to vocabulary dictionary B (act 206). In-vehicle system 100 may then confirm the transition to vocabulary dictionary B (act 208). Although, in some other embodiments, in-vehicle system 100 may not confirm the transition to vocabulary dictionary B.

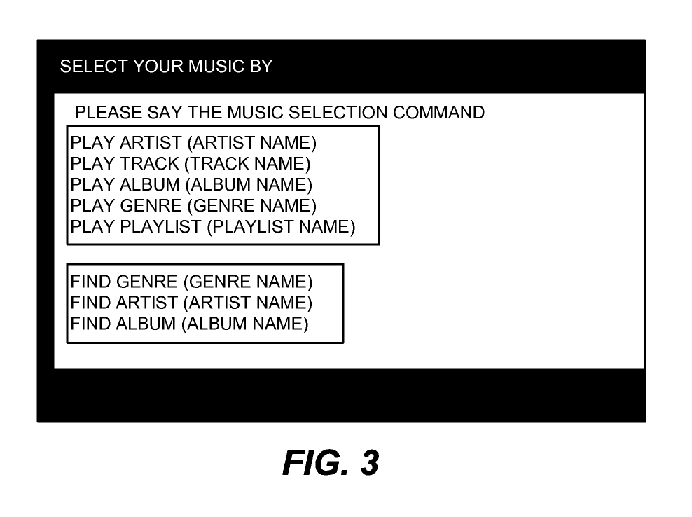

In-vehicle system 100 may confirm the transition in a number of different ways. For example, assuming that vocabulary dictionary B includes phonetics corresponding to music titles, in-vehicle system 100 may output a generated speech prompt, such as, “please provide a music title”, or another generated speech prompt, via a sound reproducing output device. In some embodiments, in-vehicle system 100 may confirm the transition to vocabulary dictionary B by displaying an overlay screen on a display device. FIG. 3 illustrates an exemplary overlay screen displaying a number of commands, which may be recognized by speech recognition component 100 using vocabulary dictionary B. As shown in FIG. 3, by displaying the exemplary overlay screen in-vehicle system 100 is confirming recognition of the speech access command.

As shown in FIG. 3, the commands recognized by speech recognition component 110 using vocabulary dictionary B may include: “play artist” followed by an artist's name; “play track” followed by a track name; “play album” followed by an album name; “play genre” followed by a genre name; “play playlist” followed by a playlist name; “find genre” followed by a genre name; “find artistic” followed by an artist's name; and “find album” followed by an album name. In other embodiments, speech recognition component 110, may use vocabulary dictionary B to recognize other commands.

After in-vehicle system 100 confirms the transition to vocabulary dictionary B, speech recognition component 110 may perform any processing that may be associated with recognizing a vocabulary dictionary B command included in the received speech input (act 210). In some cases, speech recognition component 110 may not perform processing associated with recognizing the vocabulary dictionary B command.

In-vehicle system 100 may then perform act 202 again.

If, during act 204, speech recognition component 110 determines that the received speech input does not include a speech access command, then dictionary changing component 104 may transition to vocabulary dictionary A (act 212). Speech recognition component 110 may then perform any processing that may be associated with recognizing a vocabulary dictionary A command included in the received input (act 214).

In-vehicle system 100 may then perform act 202.

The above-mentioned embodiment uses two vocabulary dictionaries. However, in other embodiments two or more vocabulary dictionaries may be used by speech recognition component 110. Each of the vocabulary dictionaries may be associated with a respective mode of operation of in-vehicle system 100 or a respective application executed by in-vehicle system 100. For example, in some embodiments, vocabulary dictionary A may include phonetics corresponding to basic speech commands, vocabulary dictionary B may include phonetics corresponding to climate control commands for a climate control mode and/or a first application, vocabulary dictionary C may include phonetics corresponding to commands for a navigation control mode and/or a second application, and vocabulary dictionary C may include phonetics corresponding to an audio control mode and/or a third application. In other embodiments speech recognition component 110 may include more vocabulary dictionaries and/or vocabulary dictionaries for other modes and applications.

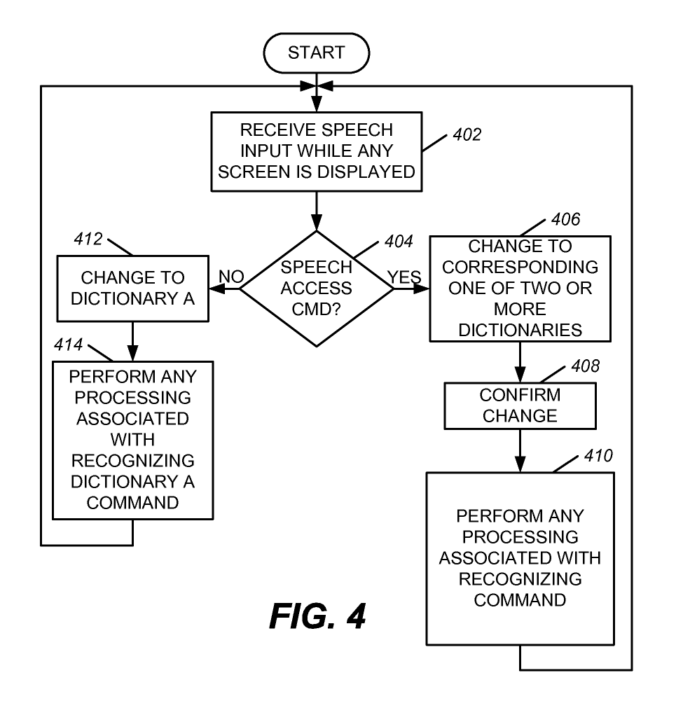

FIG. 4 is a flowchart illustrating exemplary processing in an embodiment in which speech recognition component 110 may have two or more vocabulary dictionaries. The process may begin with in-vehicle system 100 receiving speech input while operating in any mode, while executing any application associated with one of the vocabulary dictionaries, or while any screen is displayed by a display device of in-vehicle system 100 (act 402). Speech recognition component 110 may then determine whether one of a number of speech access commands is included in the received speech input (act 404). Each of the speech access commands, in this embodiment, may include a specific word or a specific phrase, such as, for example, “play music title”, “climate control”, “navigation control”, etc.

If, during act 404, speech recognition component 110 determines that the received speech input includes one of the number of speech access commands, then dictionary changing component 114 may transition a currently-used dictionary to one of the two or more vocabulary dictionaries that corresponds to the one of the number of speech access commands (act 406). In-vehicle system 100 may then confirm the transition to the one of the two or more vocabulary dictionaries (act 408). In some embodiments, in-vehicle system 100 may not confirm the transition to vocabulary dictionary B.

In an embodiment which confirms the transition, in-vehicle system 100 may confirm the transition in a number of different ways. For example, assuming that the one of the two or more vocabulary dictionaries includes phonetics corresponding to music titles, in-vehicle system 100 may output a generated speech prompt, such as, “please provide a music title”, or another generated speech prompt, via a sound reproducing output device. In some embodiments, in-vehicle system 100 may confirm the transition to the one of the two or more vocabulary dictionaries by displaying an overlay screen on a display device, such as, for example, the exemplary overlay screen of FIG. 3. In some embodiments, different overlay screens may be associated with respective vocabulary dictionaries. By displaying an exemplary overlay screen, in-vehicle system 100 is confirming recognition of the one of the number of speech access commands.

After confirming the transition to the one of the two or more vocabulary dictionaries, speech recognition component 110 may perform any processing that may be associated with recognizing a command in the received speech input (act 410). In some cases, speech recognition component 110 may not perform processing associated with recognizing the command.

In-vehicle system 100 may then perform act 402 again.

If, during act 404, speech recognition component 110 determines that the received speech input does not include one of a number of speech access commands, then dictionary changing component 104 may transition a currently-used dictionary to vocabulary dictionary A (act 412). Speech recognition component 110 may then perform any processing associated with recognizing a vocabulary dictionary A command included in the received input (act 414). Vocabulary dictionary A may include phonetics corresponding to basic commands.

In-vehicle system 100 may then perform act 402 again.

Miscellaneous

In a variation of the above-mentioned embodiments, at least some of the vocabulary dictionaries may be associated with specific algorithms that can be used to enhance, or improve, speech recognition performance while in-vehicle system 100 is operating in a mode associated with one of the at least some of the vocabulary dictionaries, or in-vehicle system 100 is executing an application associated with the one of the at least some of the vocabulary dictionaries. For example, speech recognition component 110 may supplement at least some of the vocabulary dictionaries such that specific mispronounced speech commands in speech input may be recognized. Each of the supplemented vocabulary dictionaries may be supplemented differently from other vocabulary dictionaries. In other embodiments, other algorithms or enhancements may be used to improve speech recognition performance with respect to some or all of the vocabulary dictionaries.

In the above-mentioned embodiments, when no speech access command is detected in a received speech input, speech recognition component 110 may use vocabulary dictionary A to recognize the received speech input. In other embodiments, after a transition to a particular vocabulary dictionary, speech recognition component 110 may continue to recognize received speech input using the particular vocabulary dictionary until a speech access command is detected in a received speech input, thereby causing a transition to another particular vocabulary dictionary.

### CONCLUSION

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above descriptions may contain specific details, they are not to be construed as limiting the claims in any way. Other configurations of the described embodiments are part of the scope of this disclosure. In addition, acts illustrated by the flowcharts of FIGS. 2 and 4 may be performed in a different order in other embodiments, and may include additional or fewer acts. Further, in other embodiments, other devices or components may perform portions of the acts described above. Accordingly, the appended claims and their legal equivalents define the invention, rather than any specific examples given.

1. An in-vehicle system comprising:
a speech recognition component for recognizing a speech input of a user;
a plurality of vocabulary dictionaries for use, by the speech recognition component, in recognizing the speech input, each of the plurality of vocabulary dictionaries being associated with a respective application; and
a dictionary changing component for changing a currently-used one of the plurality of vocabulary dictionaries in response to the speech recognition component recognizing a speech access command uttered by a user while the in-vehicle system is operating in any one of a plurality of modes.

2. The in-vehicle system of claim 1, further comprising:
a display device, wherein:
the in-vehicle system includes a plurality of screens for displaying on the display device, and
the dictionary changing component changes the currently-used one of the plurality of vocabulary dictionaries in response to the speech recognition component recognizing the uttered speech access command regardless of which one of the plurality of screens is currently displayed on the display device.

3. The in-vehicle system of claim 2, wherein when the dictionary changing component changes the currently-used one of the plurality of vocabulary dictionaries, the in-vehicle system causes an overlay screen to be displayed on the display device.

4. The in-vehicle system of claim 1, wherein:
the speech recognition component selectively applies a set of specific algorithms to improve speech recognition accuracy, the set of specific algorithms being based on a currently-used one of the plurality of vocabulary dictionaries.

5. The in-vehicle system of claim 1, wherein:
the speech recognition component causes a confirmation of recognition of the speech access command to be provided to the user.

6. The in-vehicle system of claim 5, wherein the confirmation includes a visual confirmation.

7. The in-vehicle system of claim 1, wherein at least one of the plurality of vocabulary dictionaries includes phonetics corresponding to music titles.

8. A method, implemented by an in-vehicle system having a speech recognition component, for changing a currently-used one of a plurality of vocabulary dictionaries used by the speech recognition component, the method comprising:
recognizing a speech access command included in a received speech input;
changing the currently-used one of the plurality of vocabulary dictionaries used by the speech recognition component based on the recognized speech access command, wherein
the method is performed by the in-vehicle system.

9. The method of claim 8, wherein the changed currently-used one of the plurality of vocabulary dictionaries is based upon which one of a plurality of speech access commands is recognized.

10. The method of claim 8, further comprising:
providing a confirmation of detecting the speech access command.

12-20. (canceled)

21. The method of claim 10, wherein the providing of the confirmation further comprises:
displaying an overlay screen on a display device of the in-vehicle system.

22. The method of claim 10, wherein the providing of the confirmation further comprises:
providing a speech-generated confirmation of recognizing the speech access command.

23. The method of claim 8, further comprising:
operating in a plurality of modes, each of the plurality of modes being associated with a respective one of the plurality of vocabulary dictionaries, wherein
the speech access command is recognizable by the speech recognition component regardless of which one of the plurality of modes is currently operational.

24. A tangible machine-readable medium having instructions recorded thereon for a processor of a computing device, such that when the instructions are executed by the processor the computing device performs a method comprising:
receiving a speech input including a speech access command;
detecting the speech access command; and
changing a currently-used vocabulary dictionary used for speech recognition in response to detecting the speech access command.

25. The tangible machine-readable medium of claim 24, wherein:
the speech access command is one of a plurality of speech access commands which the computing device is capable of recognizing, and
recognition of any one of the plurality of speech access commands causing the computing device to be in a corresponding one of a plurality of modes of operation.

26. The tangible machine-readable medium of claim 24, wherein the method further comprises:
confirming, to a user of the computing device, the detecting of the speech access command.

27. The tangible machine-readable medium of claim 26, wherein the confirming of the detecting of the speech access command comprises:
displaying an overlay screen on a display device of the computing device.

28. The tangible machine-readable medium of claim 24, wherein:
the speech access command is one of a plurality of speech access commands which the computing device is capable of recognizing, and
the method further comprises:
displaying one of a plurality of overlay screens on a display device of the computing device, the one of the plurality of overlay screens being based on the one of the plurality of speech access commands recognized.

29. The tangible machine-readable medium of claim 24, wherein:
the speech access command is one of a plurality of speech access commands which the computing device is capable of recognizing, and the method further comprises:
outputting one of a plurality of generated speech prompts to confirm the recognizing of the speech access command, the one of the plurality of generated speech prompts output being based on the one of the plurality of speech access commands recognized.
